(19) United States
(12) Patent Application Publication
(10) Pub. No.: US 2015/0329111 A1
(43) Pub. Date: Nov. 19, 2015

(54) ELEVATED PERCEPTION SYSTEM FOR AUTOMATED VEHICLES

(71) Applicant: Toyota Motor Engineering & Manufacturing North America, Inc., Erlanger, KY (US)

(72) Inventor: Danil V. Prokhorov, Canton, MI (US)

(73) Assignee: Toyota Motor Engineering & Manufacturing North America, Inc., Erlanger, KY (US)

(21) Appl. No.: 14/280,634

(22) Filed: May 18, 2014

(51) Int. Cl. B60W 30/09; B60W 10/18; B60W 10/20

(52) U.S. Cl. CPC B60W 30/09; B60W 10/20; B60W 10/18; B60W 2550/10; B60W 2550/30; B60W 2710/18; B60W 2710/20

(57) ABSTRACT

An automated driving system is disclosed. The automated driving system includes an elevated perception system disposed above a vehicle and a computing device in communication with the elevated perception system. The computing device includes one or more processors for controlling the operations of the computing device and a memory for storing data and program instructions used by the one or more processors. The one or more processors are configured to execute instructions stored in the memory to detect, based on one or more images captured by the elevated perception system, a traffic condition proximate the vehicle. The one or more processors are further configured to send a command to one or more vehicle systems to implement one or more vehicle maneuvers based on the detected traffic condition. The time to detection of the traffic condition is shorter than is possible using a traditional perception system disposed on the vehicle.

### BACKGROUND

Partially-automated or monitored driving systems are designed to assist drivers in operating a vehicle safely and efficiently on the road, for example, using techniques such as lane tracking of the vehicle to send a warning to the driver when the vehicle is leaving its lane and controlling vehicle velocity based on distance to a vehicle ahead of the driver when adaptive cruise control is activated by the driver. The early detection of traffic or environmental conditions surrounding the vehicle is thus important for optimum performance of the monitored driving system.

Fully or highly automated, e.g. autonomous or self-driven, driving systems are designed to operate a vehicle on the road either without or with low levels of driver interaction or other external controls. Given the lack of driver interaction with a fully or highly automated vehicle, early detection of traffic conditions or environmental conditions surrounding the vehicle becomes of even greater importance. Current automated driving systems do not provide sufficient lead time to plan vehicle maneuvers for some difficult to detect traffic conditions.

### SUMMARY

The automated driving system described here can operate a vehicle along a planned route based on both navigation instructions and the environment surrounding the vehicle. Response time for the automated driving system is improved by including an elevated perception system, one disposed above the vehicle, in order to detect traffic conditions such as platoons of preceding vehicles, obstacles, and intersections. The time to detection of the traffic condition is shorter than the detection time that would be required using a traditional perception system, that is, one that is mounted directly on the vehicle, for example, against the roof, on the grille, on the hood, or on the headliner of the vehicle.

In one implementation, an automated driving system is disclosed. The automated driving system includes an elevated perception system disposed above a vehicle and a computing device in communication with the elevated perception system. The computing device includes one or more processors for controlling the operations of the computing device and a memory for storing data and program instructions used by the one or more processors. The one or more processors are configured to execute instructions stored in the memory to detect, based on one or more images captured by the elevated perception system, a traffic condition proximate the vehicle and send a command to one or more vehicle systems to implement one or more vehicle maneuvers based on the detected traffic condition. The time to detection of the traffic condition is shorter than is possible using a traditional perception system disposed on the vehicle.

In another implementation, a computer-implemented method of automated driving is disclosed. The method includes detecting, based on one or more images captured by an elevated perception system disposed above a vehicle, a traffic condition proximate the vehicle and sending a command to one or more vehicle systems to implement one or more vehicle maneuvers based on the detected traffic condition. The time to detection of the traffic condition is shorter than is possible using a traditional perception system disposed on the vehicle.

In another implementation, a computing device is disclosed. The computing device includes one or more processors for controlling the operations of the computing device and a memory for storing data and program instructions used by the one or more processors. The one or more processors are configured to execute instructions stored in the memory to detect, based on one or more images captured by an elevated perception system disposed above a vehicle, a traffic condition proximate the vehicle and send a command to one or more vehicle systems to implement one or more vehicle maneuvers based on the detected traffic condition. The time to detection of the traffic condition is shorter than is possible using a traditional perception system disposed on the vehicle.

### BRIEF DESCRIPTION OF THE DRAWINGS

The description herein makes reference to the accompanying drawings wherein like reference numerals refer to like parts throughout the several views, and wherein:

FIG. 1 is a block diagram of a computing device;

FIG. 2 is a schematic illustration of an autonomous vehicle including an example elevated perception system configured to communicate with the computing device of FIG. 1;

FIG. 3A shows an example image captured by a traditional perception system of a preceding platoon of vehicles approaching an intersection;

FIG. 3B shows an example image captured by the elevated perception system of FIG. 2 of the preceding platoon of vehicles approaching the intersection of FIG. 3A;

FIG. 4A shows an example image captured by the traditional perception system of FIG. 3A of an obstacle within a planned vehicle path at an intersection;

FIG. 4B shows an example image captured by the elevated perception system of FIG. 2 of the obstacle within the planned vehicle path at the intersection of FIG. 4A; and

FIG. 5 is a logic flowchart of a process performed by the autonomous vehicle using the elevated perception system of FIG. 2.

### DETAILED DESCRIPTION

An automated driving system and methods implemented using the automated driving system are disclosed. The automated driving system can be configured to detect traffic conditions, such as platoons of preceding vehicles, obstacles, and intersections, using an elevated perception system. By early detection using an elevated perception system, the automated driving system can send commands to various vehicle systems to implement vehicle maneuvers before a time that would have been possible using a traditional perception system disposed on the vehicle. The ability to detect traffic conditions more quickly improves the overall performance of the automated driving system.

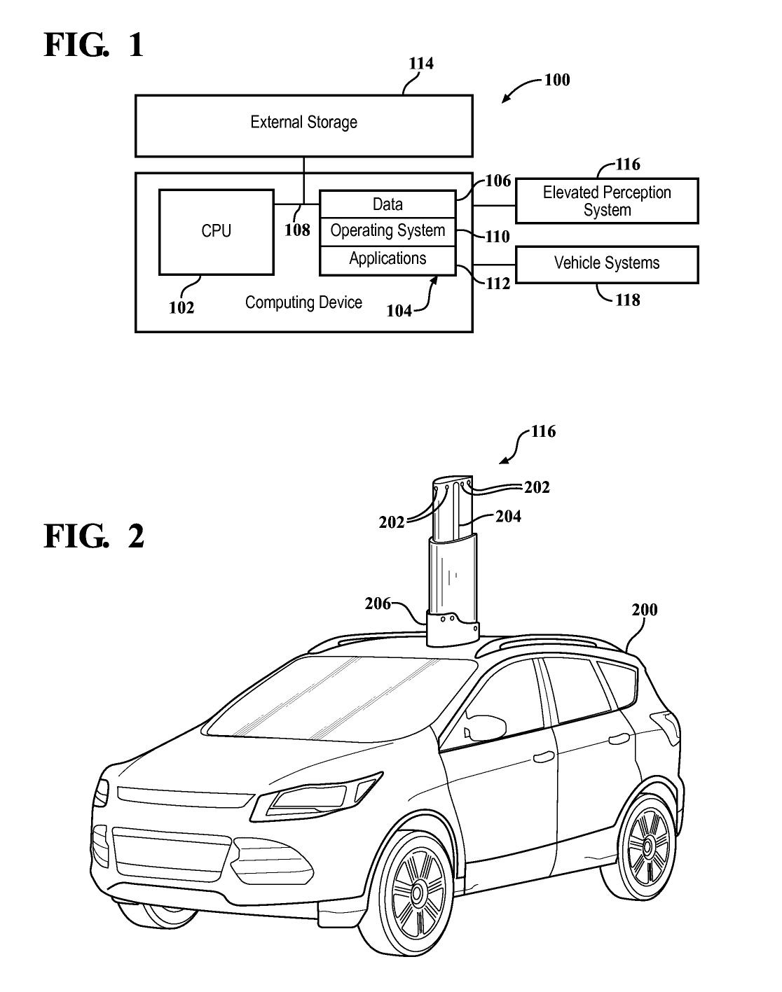

FIG. 1 is a block diagram of a computing device 100, for example, for use with the autonomous driving system. The computing device 100 can be any type of vehicle-installed, handheld, desktop, or other form of single computing device, or can be composed of multiple computing devices. The processing unit in the computing device can be a conventional central processing unit (CPU) 102 or any other type of device, or multiple devices, capable of manipulating or processing information. A memory 104 in the computing device can be a random access memory device (RAM) or any other suitable type of storage device. The memory 104 can include data 106 that is accessed by the CPU 102 using a bus 108.

The memory 104 can also include an operating system 110 and installed applications 112, the installed applications 112 including programs that permit the CPU 102 to perform the automated driving methods described below. The computing device 100 can also include secondary, additional, or external storage 114, for example, a memory card, flash drive, or any other form of computer readable medium. The installed applications 112 can be stored in whole or in part in the external storage 114 and loaded into the memory 104 as needed for processing.

The computing device 100 can also be in communication with an elevated perception system 116. The elevated perception system 116 can capture data and/or signals for processing by an inertial measurement unit (IMU), a dead-reckoning system, a global navigation satellite system (GNSS), a light detection and ranging (LIDAR) system, a radar system, a sonar system, an image-based sensor system, or any other type of system capable of capturing information specific to the environment surrounding a vehicle, including information specific to objects such as features of the route being travelled by the vehicle or other localized position data and/or signals and outputting corresponding data and/or signals to the CPU 102.

If the elevated perception system 116 captures data for a LIDAR system, ranging data relating to intensity or reflectivity returns of the environment surrounding the vehicle can be captured. In the examples described below, the elevated perception system 116 can capture, at least, camera-based images and data for a LIDAR system or other system that measures vehicle distance from other vehicles, obstacles, objects, or other geographic features including traffic lights and road signs. The computing device 100 can also be in communication with one or more vehicle systems 118, such as a vehicle braking system, a vehicle propulsion system, a vehicle steering system, etc., such that one or more of the applications 112 can send commands to the vehicle systems 118 to implement maneuvers based on the data collected by the elevated perception system 116.

FIG. 2 is a schematic illustration of an autonomous vehicle 200 including an example elevated perception system 116 configured to communicate with the computing device 100 of FIG. 1. The computing device 100 can be located within the vehicle 200 or can be located remotely from the vehicle 200 in an alternate location. If the computing device 100 is located remotely from the vehicle 200, the vehicle 200 and/or the elevated perception system 116 can include the capability of communicating with the computing device 100.

The elevated perception system 116 can include one or more sensors 202 positioned above the vehicle 200. For example, the sensors 202 can be located at the end of an extensible stanchion 204. The extensible stanchion 204 can be configured to extend to a predetermined height above the vehicle 200 during use of the elevated perception system 116 and to rotate or have multiple views to cover a 360-degree area around the vehicle 200. The extensible stanchion 204 can be disposed within a vehicle mount 206 affixed to the roof of the vehicle 200, and the vehicle mount 206 can be configured to allow the extensible stanchion 204 to both extend and retract as well as collapse and fold toward the roof of the vehicle 200 when the elevated perception system 116 is not in use or if the extensible stanchion 204 encounters an obstacle. Alternatively, the sensors 202 of the elevated perception system 116 can be disposed within a remote device, such as a remote-controlled drone or air-based device associated with the vehicle 200 and configured to capture images from a position above the vehicle 200.

The sensors 202 associated with the elevated perception system 116 can be configured to capture images for processing by an image sensor, the distance to objects within the surrounding environment for use by the computing device 100 to estimate position and orientation of the vehicle 200, or any other data and/or signals that could be used to determine the current state of the environment surrounding the vehicle 200. For example, if the sensors 202 capture data for use by a LIDAR system, laser returns from physical objects or geographic features in the area surrounding the vehicle 200 are captured and images can be formed based on ranging distances calculated by measuring the time it takes for a signal to return to the sensors 202. If the sensors 202 are camera-based, the sensors 202 can be positioned on the extensible stanchion 204 in order to provide a “bird's-eye view” of the entire environment surrounding the vehicle 200.

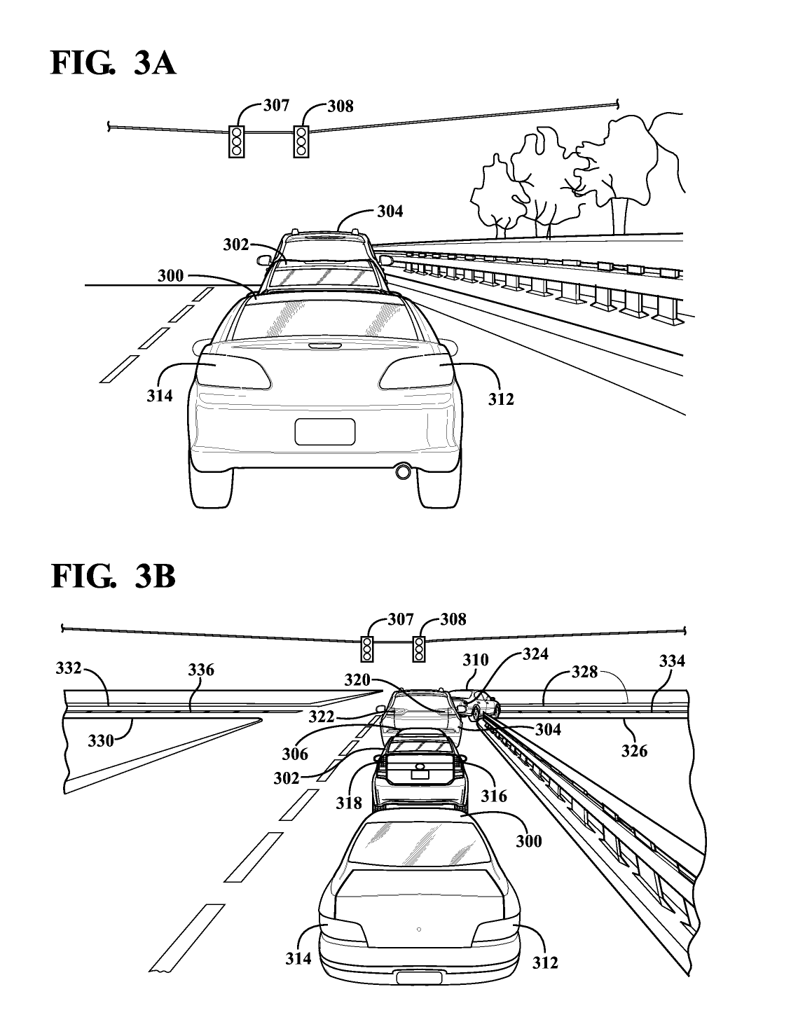

FIG. 3A shows an example image captured by a traditional perception system of a preceding platoon of vehicles approaching an intersection. A preceding platoon of vehicles is one example of a traffic condition. In this image, there appear to be three vehicles 300, 302, 304 in the platoon preceding the vehicle 200 capturing the image. The presence of the intersection is indicated only by the existence of traffic signals 307, 308, and the structure of the branches of the intersection cannot be determined from the vantage point of the traditional perception system. The vantage point of this image is based on the use of a vehicle mount to locate the traditional perception system. The vehicle mount can be an exterior mount, such as a mount directly against the roof of the vehicle 200, a mount on the hood of the vehicle 200, or a mount on the grille of the vehicle 200. Alternatively, the vehicle mount can be an interior mount, such as a mount installed along the headliner of the vehicle 200 with the traditional perception system configured to capture an image through the windshield of the vehicle 200.

FIG. 3B shows an example image captured by the elevated perception system 116 of FIG. 2 of the preceding platoon of vehicles approaching the intersection of FIG. 3A. In this image, it is clear that there are actually five vehicles 300, 302, 304, 306, 310 in the platoon preceding the vehicle 200 capturing the image. The elevated perception system 116 thus provides a more accurate representation of the physical environment proximate the vehicle 200. The vantage point of this image is based on the use of the elevated perception system 116, one that is disposed above the vehicle 200, for example, on the extensible stanchion 204 described in FIG. 2 or within a remote device associated with the vehicle 200, such as a robotic drone. This vantage point is closer to a “bird's-eye view” and provides details hidden from a traditional perception system mounted directly on the vehicle 200.

The elevated perception system 116 allows the automated driving system associated with the vehicle 200 to identify and monitor multiple vehicle taillights in the preceding platoon of vehicles. For example, taillights 312, 314 are visible and associated with the vehicle 300 (also shown in FIG. 3A), taillights 316, 318 are visible and associated with the vehicle 302, taillights 320, 322 are visible and associated with the vehicle 304, and a single taillight 324 is visible and associated with the vehicle 310. By monitoring the changes in the brightness of the taillights 312, 314, 316, 318, 320, 322, 324 using images captured by the elevated perception system 116, the automated driving system can determine when other drivers engage the brakes in each of the vehicles 300, 302, 304, 310 and can send commands to one or more vehicle systems 118 to control the vehicle 200 accordingly, by, for example, accelerating and braking at the appropriate intervals. In contrast, the traditional perception system of FIG. 3A mounted directly on the vehicle 200 only allows monitoring of the taillights 312, 314 associated with vehicle 300, one vehicle ahead of vehicle 200. The response time of automated driving system will be much slower using a traditional perception system than is possible with the elevated perception system 116.

In another example, the automated driving system can use the presence of the platoon of preceding vehicles 300, 302, 304, 306, 310 within the example image of FIG. 3B to identify a traffic jam, another traffic condition more quickly and accurately recognized using the elevated perception system 116 than would be possible using a traditional perception system mounted on the vehicle 200. The traffic jam can be identified using both the taillights 312, 314, 316, 318, 320, 322, 324 of the preceding vehicles 300, 302, 304, 310, and, for example, the roof of the preceding vehicle 306 since taillights are not visible, or are not fully visible, within the image for the vehicle 306. Based on both the recognized presence of the traffic jam and relevant characteristics of the traffic jam (e.g. number of vehicles within the traffic jam), the automated driving system can be configured to send a command to one or more vehicle systems 118 to navigate around the traffic jam or determine a better navigation route for the vehicle 200.

In another example, the automated driving system can identify the presence and the structure of an upcoming intersection, another type of traffic condition. In the example image of FIG. 3B, the “bird's eye view” vantage point of the elevated perception system 116 allows the automated driving system to detect the lane edges 326, 328, 330, 332 and dotted centerlines 334, 336 of a two-lane road intersecting the current path of travel of the vehicle 200. These intersection details are not present in the image of FIG. 3A captured by the traditional perception system mounted on the vehicle 200. Early identification of intersection features such as lane edges 326, 328, 330, 332 and centerlines 334, 336 allows the automated driving system to plan to perform an appropriate driving maneuver, such as steering, accelerating, or braking, well before the intersection is reached, improving the performance of the automated driving system.

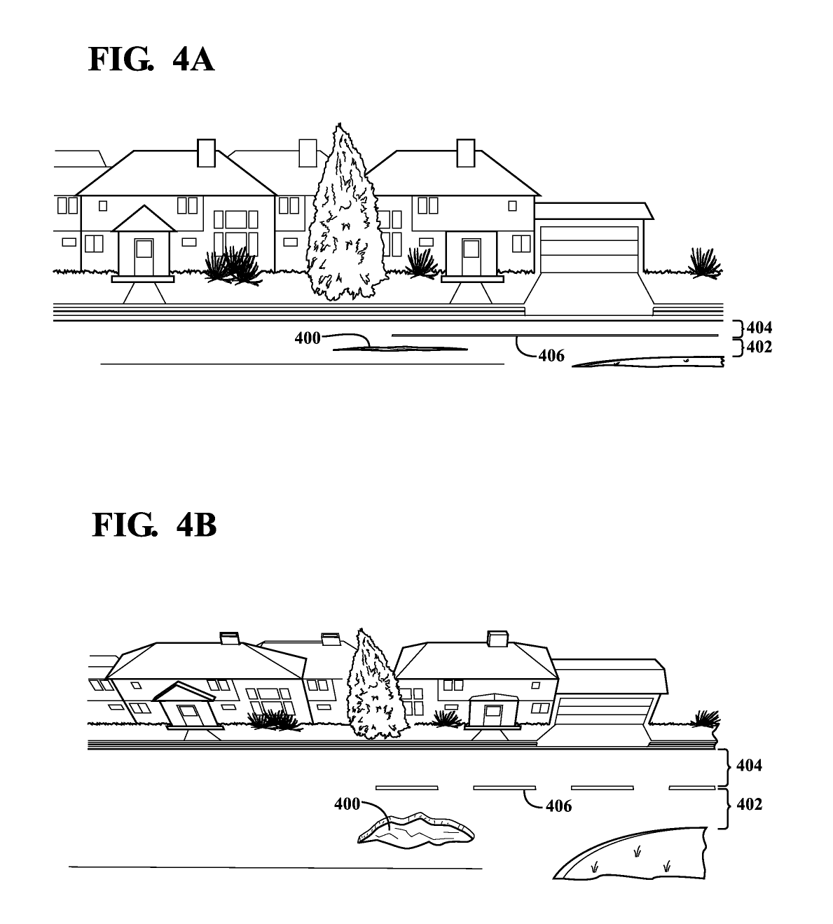

FIG. 4A shows an example image captured by the traditional perception system of FIG. 3A of an obstacle 400 within a planned vehicle path at an intersection. In this example, the obstacle 400 appears to be a small obstruction or object between the vehicle's 200 current position and the first lane 402 of an intersecting road. The second lane 404 of the intersecting road also appears to be separated from the first lane 402 by a solid centerline 406, indicating that no passing is possible at this location using lanes 402, 404. In this image, the obstacle 400 does not appear to be of great interest to the automated vehicle system, and one or more vehicle systems 118 could receive a command from the automated driving systems to drive over the obstacle 400 when traveling from the vehicle's 200 present position into lane 402 by making a right-hand turn.

FIG. 4B shows an example image captured by the elevated perception system 116 of FIG. 2 of the obstacle 400 within the planned vehicle path at the intersection of FIG. 4A. In this example image, it is clearer that the obstacle 400 is a large obstruction, for example, a deep pothole within the road between the vehicle's 200 current position and the lane 402. A deep pothole either within or proximate the path of the vehicle 200 is another type of traffic condition where early recognition by the automated driving system is important. When accurately identified as a deep pothole, the automated driving system can be configured to send a command to one or more vehicle systems 118 to navigate around the obstacle 400 instead of following a path through the deep pothole. The image provided by the elevated perception system 116 is more useful than that provided by the traditional perception system since driving over the obstacle 400 could damage the vehicle 200.

In addition, the details of the intersection present within the “bird's eye view” image of FIG. 4B are more accurate than in the traditional perception system image of FIG. 4A because the “bird's eye view” image includes more detail of the both the road in front of the vehicle 200 and traffic conditions present in the path of the vehicle 200. For example, lane widths, overall width of the road, lane markings, and traffic signs can be detected both earlier than and in more accurate detail than is possible using a traditional perception system. In FIG. 4B, it is clear that the centerline 406 between the lanes 402, 404 is a dotted line, not a solid line, indicating that other vehicles would be free to pass each other between the lanes 402, 404 at the point where the vehicle 200 is entering the intersection. Thus, the automated driving system can be configured to identify other vehicles in both of the lanes 402, 404 for autonomous navigation purposes. If the automated driving system relied on the image captured using the traditional perception system in FIG. 4A, the automated vehicle system could inaccurately decide to monitor only the lane 402 during a right-turn maneuver.

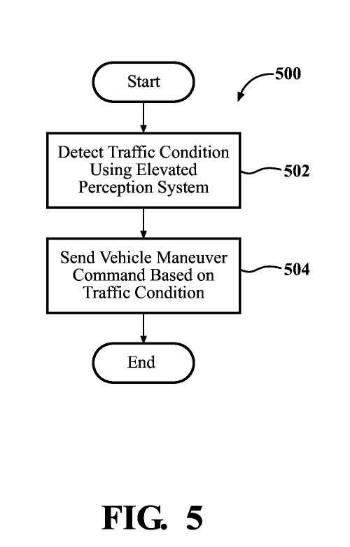

FIG. 5 is a logic flowchart of a process 500 performed by the autonomous vehicle 200 using the elevated perception system 116 of FIG. 2. In step 502 of the process 500, the computing device 100 associated with the autonomous vehicle 200 can detect a traffic condition proximate the vehicle 200 based on one or more images captured by the elevated perception system 116, that is, a perception system disposed above the vehicle. As described above, the elevated perception system 116 can include sensors 202 disposed at one end of an extensible stanchion 204 extending above the vehicle 200. Alternatively, the elevated perception system 116 can be located in a remote device configured to capture images from a position above the vehicle 200, such as a drone or robotic device.

One traffic condition that can be identified within the images captured by the elevated perception system 116 is an obstacle, such as a pothole, as described in reference to FIGS. 4A, 4B. Other obstacles can include such items as debris, construction markers, flooded roads, etc. Another traffic condition that can be identified within the images captured by the elevated perception system 116 is a preceding platoon of vehicles in front of the autonomous vehicle 200 as described in reference to FIGS. 3A, 3B. The preceding platoon of vehicles can be both identified and monitored using the state and position of taillights and vehicles roofs within the captured images. Another traffic condition that can be identified within the images captured by the elevated perception system 116 is an upcoming traffic intersection as described in reference to FIGS. 3A, 3B, 4A, 4B.

In step 504 of the process, the computing device associated with the autonomous vehicle 200 can send a command to one or more vehicle systems 118 to implement one or more vehicle maneuvers based on the detected traffic condition. If the traffic condition is an obstacle, the vehicle maneuvers can include steering, accelerating, or braking, for example, in order to avoid the obstacle. If the traffic condition is a preceding platoon of vehicles, the vehicle maneuvers can include accelerating or braking, for example, if the taillights of the vehicles can be used to determine the braking and accelerating behavior of the preceding platoon of vehicles. If the traffic condition is an intersection, the vehicle maneuvers can include steering, accelerating, or braking, for example, in order to navigate the autonomous vehicle 200 through the intersection.

In both steps 502, 504 of the process, the traffic condition can be detected by the elevated perception system 116 more quickly than is possible using a traditional perception system disposed directly on the vehicle 200. A traditional perception system can be disposed on a vehicle mount. The vehicle mount can include, for example, a vehicle interior mount, such as a mount on the headliner near the windshield, or a vehicle exterior mount, such as a direct mount to the roof of the vehicle 200 without elevation above the roof, or a mount near the front of the vehicle 200, such as on the hood or grille of the vehicle. When the time to detection of the traffic condition is shorter than is possible with a traditional perception system, the automated driving system can respond more quickly to the traffic condition.

The elevated perception system 116 can also be used in the place of cooperative adaptive cruise control (C-ACC). C-ACC relies on vehicle-to-vehicle (V2V) communication in order to enable effective lateral control of the autonomous vehicle 200 by passing vehicle speed and location data between vehicles proximate to the autonomous vehicle 200. The ability to monitor the position, speed, braking, and accelerating of vehicles proximate to the autonomous vehicle 200 using the elevated perception system 116 would eliminate the need for V2V communication. Another advantage of the elevated perception system 116 is that the sensors 202 are less likely than those positioned on a traditional perception system to be adversely affected by headlights of oncoming vehicles. The elevated perception system 116 could also capture images for use by one or more driver assistance applications, such as a parking-assist system, back-up assist system, etc. Driver assistance systems would also benefit from the “bird's eye view” images available from the elevated perception system 116.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims. The scope of the claims is to be accorded the broadest interpretation so as to encompass all such modifications and equivalent structures as is permitted under the law.

What is claimed is:

1. An automated driving system, comprising:
an elevated perception system disposed above a vehicle; and
a computing device in communication with the elevated perception system, comprising:
one or more processors for controlling the operations of the computing device; and
a memory for storing data and program instructions used by the one or more processors, wherein the one or more processors are configured to execute instructions stored in the memory to:
detect, based on one or more images captured by the elevated perception system, a traffic condition proximate the vehicle;
send a command to one or more vehicle systems to implement one or more vehicle maneuvers based on the detected traffic condition; and
wherein a time to detection of the traffic condition is shorter than is possible using a traditional perception system disposed on the vehicle.

2. The system of claim 1, wherein the elevated perception system disposed above the vehicle is disposed at an end of an extensible stanchion and wherein the extensible stanchion is configured to extend to a predetermined height above the vehicle.

3. The system of claim 1, wherein the elevated perception system disposed above the vehicle is disposed in a remote device and wherein the remote device is configured to capture images from a position above the vehicle.

4. The system of claim 1, wherein the traditional perception system is disposed on a vehicle mount, the vehicle mount including one of a vehicle exterior mount and a vehicle interior mount.

5. The system of claim 1, wherein the traffic condition is an obstacle proximate a path of the vehicle and the one or more vehicle maneuvers include at least steering and accelerating and braking.

6. The system of claim 1, wherein the traffic condition is a preceding platoon of vehicles and the one or more vehicle maneuvers include at least accelerating and braking.

7. The system of claim 6, wherein detection of the preceding platoon of vehicles is based on one or more images of taillights and vehicle roofs associated with the preceding platoon of vehicles.

8. The system of claim 1, wherein the traffic condition is an intersection and the one or more vehicle maneuvers include at least steering and accelerating and braking.

9. A computer-implemented method of automated driving, comprising:
detecting, based on one or more images captured by an elevated perception system disposed above a vehicle, a traffic condition proximate the vehicle;
sending a command to one or more vehicle systems to implement one or more vehicle maneuvers based on the detected traffic condition; and
wherein a time to detection of the traffic condition is shorter than is possible using a traditional perception system disposed on the vehicle.

10. The method of claim 9, wherein the elevated perception system disposed above the vehicle is disposed at an end of an extensible stanchion and wherein the extensible stanchion is configured to extend to a predetermined height above the vehicle.

11. The method of claim 9, wherein the elevated perception system disposed above the vehicle is disposed in a remote device and wherein the remote device is configured to capture images from a position above the vehicle.

12. The method of claim 9, wherein the traditional perception system is disposed on a vehicle mount, the vehicle mount including one of a vehicle exterior mount and a vehicle interior mount.

13. The method of claim 9, wherein the traffic condition is a preceding platoon of vehicles and the one or more vehicle maneuvers include at least accelerating and braking.

14. The method of claim 13, wherein detection of the preceding platoon of vehicles is based on one or more images of taillights and vehicle roofs associated with the preceding platoon of vehicles.

15. A computing device, comprising:
one or more processors for controlling the operations of the computing device; and
a memory for storing data and program instructions used by the one or more processors, wherein the one or more processors are configured to execute instructions stored in the memory to:
detect, based on one or more images captured by an elevated perception system disposed above a vehicle, a traffic condition proximate the vehicle;
send a command to one or more vehicle systems to implement one or more vehicle maneuvers based on the detected traffic condition; and
wherein a time to detection of the traffic condition is shorter than is possible using a traditional perception system disposed on the vehicle.

16. The device of claim 15, wherein the elevated perception system disposed above the vehicle is disposed at an end of an extensible stanchion and wherein the extensible stanchion is configured to extend to a predetermined height above the vehicle.

17. The device of claim 15, wherein the elevated perception system disposed above the vehicle is disposed in a remote device and wherein the remote device is configured to capture images from a position above the vehicle.

18. The device of claim 15, wherein the traditional perception system is disposed on a vehicle mount, the vehicle mount including one of a vehicle exterior mount and a vehicle interior mount.

19. The device of claim 15, wherein the traffic condition is an obstacle proximate a path of the vehicle and the one or more vehicle maneuvers include at least steering and accelerating and braking.

20. The device of claim 15, wherein the traffic condition is an intersection and the one or more vehicle maneuvers include at least steering and accelerating and braking.
